(19) United States
(12) Patent Application Publication
(10) Pub. No.: US 2024/0153679 A1
(43) Pub. Date: May 9, 2024

(54) RESISTOR, VARIABLE RESISTOR, AND METHOD FOR MANUFACTURING RESISTOR

(71) Applicant: Tokyo Cosmos Electric Co., Ltd., Kanagawa (JP)

(72) Inventors: Masaru SATO, Kanagawa (JP); Hitoshi OZAKI, Kanagawa (JP); Yuya HIGASA, Kanagawa (JP)

(73) Assignee: Tokyo Cosmos Electric Co., Ltd., Kanagawa (JP)

(21) Appl. No.: 18/283,013

(22) PCT Filed: Mar. 22, 2022
(86) PCT No.: PCT/JP2022/013135

§ 371 Date: Sep. 20, 2023

(30) Foreign Application Priority Data
Mar. 25, 2021 (JP) 2021-021256

(51) Int. Cl. H01C 17/065

(52) U.S. Cl. CPC H01C 17/065

(57) ABSTRACT

With a resistor, a variable resistor, and a method for manufacturing a resistor according to the present invention, it is possible to eliminate lead and prevent deterioration of sliding characteristics. A resistor according to the present invention is disposed on an insulating layer. The resistor has: a more-conductive-material-containing layer containing more conductive materials than insulating materials; and a more-insulating-material-containing layer that does not contain lead and that contains more insulating materials than conductive materials. The more-conductive-material-containing layer has a polished surface. For example, the film thickness of the more-conductive-material-containing layer in a low-resistance region having a resistance value smaller than or equal to a prescribed value is larger than the film thickness of the more-insulating-material-containing layer in a high-resistance region having a resistance value larger than the prescribed value.

### TECHNICAL FIELD

The present invention relates to a resistor, a variable resistor, and a method for manufacturing a resistor.

### Background Art

For example, Patent Literature (hereinafter referred to as “PTL”) 1 discloses a variable resistor including: an insulating layer formed on surfaces of a metal plate; a resistor formed as a coating film on the insulating layer; and a contact (slider), such as a metal brush, that is movable to any position on the resistor.

Further, from the viewpoint of environmentally friendly manufacture of products, for example, a material free of lead (Pb) is used for a resistor (lead-freeness).

### CITATION LIST

### Patent Literature

PTL 1
Japanese Patent Application Laid-Open No. 2008-283209

### SUMMARY OF INVENTION

### Technical Problem

Incidentally, for realizing lead-freeness, conductive particles included in a material for a resistor increase, which increases the roughness of a film surface of the resistor, and thus, wear of a contact tends to increase. As a result, there is a problem that sliding characteristics such as electrical characteristics and life characteristics deteriorate.

An object of the present invention is to provide a resistor, a variable resistor, and a method for manufacturing a resistor each capable of realizing lead-freeness and preventing deterioration of sliding characteristics.

### Solution to Problem

To achieve the above object, a resistor in the present invention is a resistor disposed on an insulating layer. The resistor includes a more-conductor-containing layer, which contains more conductors than insulators, and a more-insulator-containing layer, which is free of lead and contains more insulators than conductors. The more-conductor-containing layer includes a polished surface.

Further, a variable resistor in the present invention includes the resistor described above.

Further, a method for manufacturing a resistor in the present invention includes: forming a coating film on an insulating layer by using a resistor ink free of lead; and polishing a film surface of the coating film such that a polishing amount of the coating film is in a range of 0.1% to 10% with respect to a coating film amount of the coating film.

### Advantageous Effects of Invention

The present invention makes it possible to realize lead-freeness and to prevent deterioration of sliding characteristics.

### BRIEF DESCRIPTION OF DRAWINGS

FIG. 1 is a perspective view illustrating an example of a variable resistor according to an embodiment of the present invention;

FIG. 2A is a cross-sectional view of a low-resistance region before polishing;

FIG. 2B is a cross-sectional view of the low-resistance region after the polishing;

FIG. 3A is a cross-sectional view of a high-resistance region before the polishing; and

FIG. 3B is a cross-sectional view of the high-resistance region after the polishing.

### DESCRIPTION OF EMBODIMENTS

Hereinafter, an embodiment of the present invention will be described with reference to the accompanying drawings.

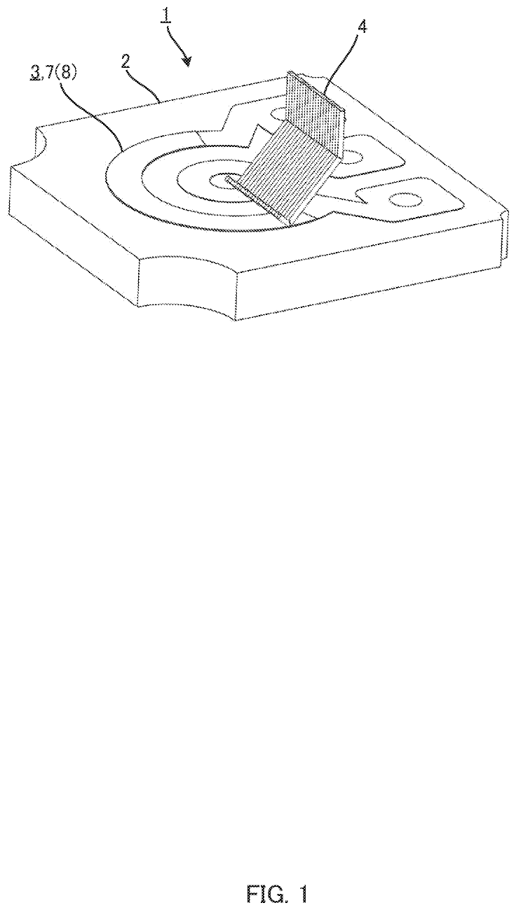

FIG. 1 is a perspective view illustrating an example of variable resistor 1 according to an embodiment of the present invention.

As illustrated in FIG. 1, variable resistor 1 includes: ceramic substrate 2 that is an insulating layer; resistor 3 formed as a coating film on ceramic substrate 2; and contact 4 (slider) that is moveable to any position on the resistor 3.

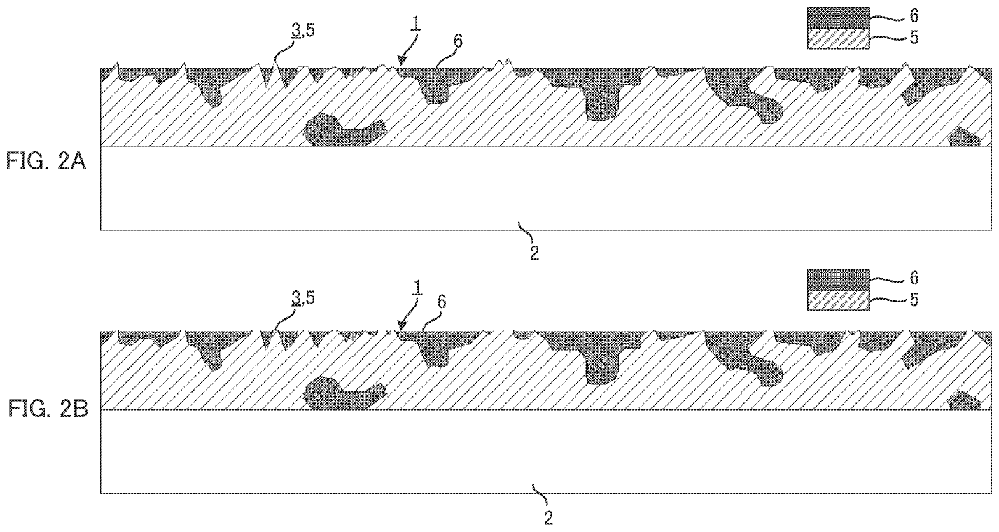

Resistor 3 is formed on ceramic substrate 2 by a resistor ink. Resistor 3 includes: more-conductor-containing layer 5 that contains more conductors than insulators; and more-insulator-containing layer 6 that contains more insulators than conductors (see FIGS. 2A and 2B). In the following description, more-conductor-containing layer 5 and more-insulator-containing layer 6 will be collectively referred to as “coating film”.

Next, a method for manufacturing resistor 3 will be described.

First, a resistor ink free of lead is applied on ceramic substrate 2 and is baked thereon after the application to thereby form more-conductor-containing layer 5 and more-insulator-containing layer 6. As the resistor ink, for example, a conductive material formed of a paste of silver, copper or a silver/copper hybrid and an insulating material free of lead and formed of a glass paste are blended.

The resistor coating after the baking of the resistor ink has a prescribed roughness with a peak(s) and a bottom(s). Thus, the front surface of resistor 3 is formed of a film surface (peak(s)) of more-conductor-containing layer 5 and a film surface of more-insulator-containing layer 6. In the following description, the front surface of resistor 3 will be simply referred to as “film surface of the coating film”.

Next, the film surface of the coating film is polished. In other words, the front surface of resistor 3 is polished. For the polishing of the film surface, a known measure such as buffing, barreling, and lapping is used. Note that, the film surface is polished while measuring the resistance value of the coating film. The polishing amount is 0.1% to 10% with respect to the coating film amount (the coating film amount of more-conductor-containing layer 5 and the coating film amount of more-insulator-containing layer 6) before the polishing. The polishing amount is preferably 0.1% to 3%. Note that, the polishing amount is determined based on an increased amount (0.1% to 10%) in the resistance value of the coating film (the coating film of more-conductor-containing layer 5 and the coating film of more-insulator-containing layer 6) in low-resistance region 7 after the polishing with respect to the resistance value of the coating film before the polishing.

As illustrated in FIG. 1, as resistor 3, there are low-resistance region 7 having a resistance value (for example, 10 Ω to 10 kΩ) and high-resistance region 8 having a resistance value (for example, 1 kΩ to 5 MΩ). In a case where low-resistance region 7 and high-resistance region 8 are compared, the manufacturing methods thereof are basically the same, but more-conductor-containing layer 5 and more-insulator-containing layer 6 differ in the film thickness and the polishing of the film surface.

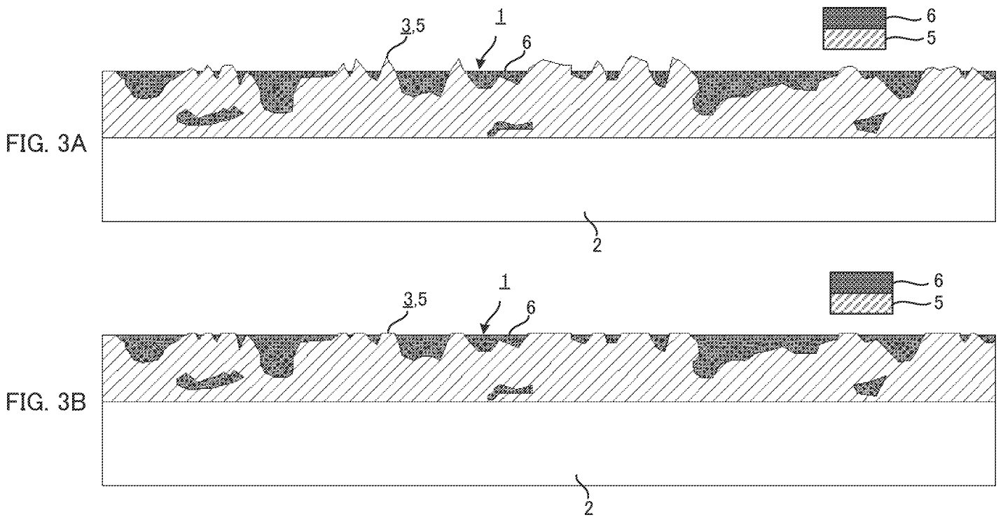

FIG. 2A is a cross-sectional view of low-resistance region 7 before the polishing. FIG. 2B is a cross-sectional view of low-resistance region 7 after the polishing. FIG. 3A is a cross-sectional view of high-resistance region 8 before the polishing. FIG. 3B is a cross-sectional view of high-resistance region 8 after the polishing.

As illustrated in FIGS. 2A and 3A, before the polishing, the film thickness of more-insulator-containing layer 6 in low-resistance region 7 is thinner than the film thickness of more-insulator-containing layer 6 in high-resistance region 8. Thus, the ratio of the film surface area of more-conductor-containing layer 5 to the front surface area of resistor 3 before the polishing is larger in low-resistance region 7 than in high-resistance region 8. This is due to the difference in material ratio as in the ink for the low resistance contains more conductive materials and fewer insulating materials, whereas the ink for the high resistance contains fewer conductive materials and more insulating materials.

A comparison between FIGS. 2A and 2B makes it understandable that in film surface polishing in low-resistance region 7, peaks in more-conductor-containing layer 5 are polished. Thus, the cross-sectional area of more-conductor-containing layer 5 decreases and the total resistance value increases. Further, since the roughness of the film surface decreases, wear of contact 4 (see FIG. 1) decreases. Note that, the total resistance value of resistor 3 is set to be lower in advance so as to be an appropriate value after the polishing.

A comparison between FIGS. 3A and 3B makes it understandable that in film surface polishing in high-resistance region 8, peaks in more-conductor-containing layer 5 are polished. Thus, the cross sectional area of more-conductor-containing layer 5 decreases and the total resistance value increases. Further, since the roughness of the film surface decreases, wear of contact 4 (see FIG. 1) decreases. Further, in a case where the film surface of more-insulator-containing layer 6 is polished, the roughness of the film surface decreases by removing a vitreous material that is in contact with contact 4, and thus, it is possible to decrease wear of contact 4 and to enhance sliding characteristics. Note that, the total resistance value of resistor 3 is set to be lower in advance so as to be an appropriate value after the polishing.

Resistor 3 according to the embodiment described above is a resistor formed as a coating film (more-conductor-containing layer 5, and more-insulator-containing layer 6 free of lead) on ceramic substrate 2, the coating film includes a polished film surface, and the coating amount of the coating film is in a range of 0.1% to 10% with respect to the coating film amount of the coating film before the polishing.

With the configuration described above, the resistor is formed as more-conductor-containing layer 5, and more-insulator-containing layer 6 free of lead, it is possible to realize lead-freeness. Further, since the roughness of the film surface decreases by polishing the film surface of the coating film, it is possible to decrease wear of contact 4 and to prevent deterioration of sliding characteristics.

Further, in resistor 3 according to the embodiment described above, the polishing amount of the coating film is determined based on an increased amount in the resistance value of the coating film after the polishing with respect to the resistance value of the coating film before the polishing. Thus, it is possible to polish a prescribed amount by polishing the film surface while referring to the increased amount in the resistance value.

Further, in resistor 3 according to the embodiment described above, the coating film includes more-conductor-containing layer 5 formed of conductive materials and more-insulator-containing layer 6 formed of insulating materials on more-conductor-containing layer 5. Since the roughness of the film surface of more-conductor-containing layer 5 is large in comparison with the roughness of the film surface of more-insulator-containing layer 6, peaks in the film surface of more-conductor-containing layer 5 are exposed without being covered by more-insulator-containing layer 6 depending on the film thickness. Thus, it is possible to adjust the resistance value of the coating film according to the polishing amount of the film surface of more-conductor-containing layer 5.

Further, in resistor 3 according to the embodiment described above, more-conductor-containing layer 5 includes a polished film surface. Polishing a peak(s) in the film surface of more-conductor-containing layer 5 makes it possible to adjust the resistance value of the coating. Note that, in this case, the film surface of more-insulator-containing layer 6 may be polished or may not be polished.

In addition, any of the embodiment described above is only illustration of an exemplary embodiment for implementing the present invention, and the technical scope of the present invention shall not be construed limitedly thereby. That is, the present invention can be implemented in various forms without departing from the gist thereof or the main features thereof.

Note that, in resistor 3 according to the embodiment described above, the resistance value of the coating film is adjusted by polishing only the film surface (peak(s)) of more-conductor-containing layer 5, but the respective film surfaces of more-conductor-containing layer 5 and more-insulator-containing layer 6 may be polished. For example, a vitreous material is removed from the film surface by polishing more-insulator-containing layer 6, and thus, the roughness of the film surface decreases, wear of contact 4 decreases, and sliding characteristics can be further enhanced.

This application is based on Japanese patent application No. 2021-051256, filed Mar. 25, 2021, the contents of which are incorporated herein by reference.

### INDUSTRIAL APPLICABILITY

The present invention is suitably utilized in a variable resistor including a resistor which is required to realize lead-freeness and to prevent deterioration of sliding characteristics.

### REFERENCE SIGNS LIST

1 Variable resistor
2 Ceramic substrate
3 Resistor
4 Contact (slider)
5 More-conductor-containing layer
6 More-insulator-containing layer
7 Low-resistance region
8 High-resistance region

1. A resistor disposed on an insulating layer, wherein:
the resistor comprises a more-conductor-containing layer and a more-insulator-containing layer, the more-conductor-containing layer containing more conductors than insulators, the more-insulator-containing layer being free of lead and containing more insulators than conductors; and
the more-conductor-containing layer includes a polished surface.

2. The resistor according to claim 1, wherein a film thickness of the more-conductor-containing layer in a low-resistance region is thicker than a film thickness of the more-insulator-containing layer in a high-resistance region, the low-resistance region being a low-resistance region in which a resistance value is equal to or lower than a prescribed value, the high-resistance region being a high-resistance region in which the resistance value is higher than the prescribed value.

3. A variable resistor, comprising the resistor according to claim 1.

4. A method for manufacturing a resistor, comprising:
forming a coating film on an insulating layer by using a resistor ink free of lead; and
polishing a film surface of the coating film such that a polishing amount of the coating film is in a range of 0.1% to 10% with respect to a coating film amount of the coating film.

5. The method for manufacturing the resistor according to claim 4, wherein the polishing amount is determined based on an increased amount in a resistance value of the coating film after the polishing with respect to the resistance value of the coating film before the polishing.
